(19) United States
(12) Patent Application Publication
(10) Pub. No.: US 2009/0318130 A1
(43) Pub. Date: Dec. 24, 2009

(54) METHOD AND APPARATUS FOR MONITORING OUTBOUND COMMUNICATIONS AT A COMMUNICATION DEVICE

(75) Inventors: Joe G. Naylor, Newton, MA (US); George Emilov, Montrose, CA (US); Nikolay Borisov Bankov, Montrose, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: WEBMESSENGER, INC., Tujunga, CA (US)

(21) Appl. No.: 12/110,262

(22) Filed: Apr. 25, 2008

(51) Int. Cl. H04W 24/00

(52) U.S. Cl. 455/423

(57) ABSTRACT

An apparatus and method are disclosed for monitoring outbound communications at a communication device, involving a monitoring module and a rule module. The monitoring module is configured to receive at least one indicator that an outbound text-based communication is queued for transmission from a communication device. The monitoring module is configured to receive at least one indicator produced in response to a request to establish an audio communication link between the communication device and a server. The rule module is in communication with the monitoring module. The rule module is configured to analyze a portion of the outbound text-based communication in response to the at least one indicator for the outbound text-based communication. The rule module is configured to analyze a portion of a signal associated with the audio communication link in response to the at least one indicator associated with the request.

### BACKGROUND

The present disclosure relates to the monitoring of electronic communications. In particular, it relates to methods and apparatus for monitoring outbound communications at a communication device.

### SUMMARY

The present disclosure relates to an apparatus and method for monitoring outbound communications at a communication device utilizing a monitoring module and a rule module. In one or more embodiments, the monitoring module is associated with a communication device. The monitoring module is configured to receive at least one indicator that an outbound text-based communication is queued for transmission from the communication device. In addition, the monitoring module is configured to receive at least one indicator produced in response to a request to establish an audio communication link between the communication device and a server.

In one or more embodiments, the rule module is in communication with the monitoring module. The rule module is configured to analyze a portion of the outbound text-based communication in response to the at least one indicator for the outbound text-based communication. Additionally, the rule module is configured to analyze a portion of a signal associated with the audio communication link in response to the at least one indicator associated with the request.

### DRAWINGS

These and other features, aspects, and advantages of the present disclosure will become better understood with regard to the following description, appended claims, and accompanying drawings where:

FIG. 1 is a schematic block diagram that illustrates an outbound-communication monitoring module configured to monitor one or more outbound communications before transmission from a communication device, according to at least one embodiment of the present disclosure.

FIG. 2 is a schematic block diagram that illustrates a communication device that has an outbound-communication monitoring module, an operating system, communication modules, and a user-interface, according to at least one embodiment of the present disclosure.

FIG. 3 is a table that illustrates rules and actions, according to at least one embodiment of the present disclosure.

FIG. 4 is a timing diagram that illustrates a sequence of functions performed at a communication device and/or signals transmitted between components of the communication device, according to at least one embodiment of the present disclosure.

FIG. 5 is a flowchart that illustrates a method for monitoring outbound e-mail from an e-mail module at a communication device, according to at least one embodiment of the present disclosure.

FIG. 6 is a flowchart that illustrates a method for monitoring outbound short-message-service (SMS) messages from an SMS module at a communication device, according to at least one embodiment of the present disclosure.

FIG. 7 is a flowchart that illustrates a method for monitoring outbound voice communications at a communication device, according to at least one embodiment of the present disclosure.

### DETAILED DESCRIPTION

The apparatus and methods disclosed herein provide an operative system for monitoring electronic communications. Specifically, this system employs methods and apparatus for monitoring outbound communications at a communication device.

Electronic communications such as text messages and e-mail messages can be created and distributed with relative ease using a variety of communication devices such as personal computers or handheld wireless devices. Consequently, a sender may, for example, inadvertently send an electronic message to an unintended recipient or accidentally include information not intended for distribution at all in an electronic message. In some instances, a sender may intentionally include information in an electronic message that may be contrary to a company policy. Although some known applications have been developed to intercept and filter these types of electronic messages to prevent delivery to the inboxes of users, these applications are often configured to intercept messages well after they have been transmitted from a communication device. For example, some known filtering applications are configured to operate at a server level and intercept electronic messages after they have been sent over one or more networks, cached in a memory, and/or re-transmitted multiple times. Thus, a need exists for methods and apparatus for monitoring of outbound communications at a communication device before the outbound communication is transmitted.

In one or more embodiments of the present disclosure, a method for monitoring outbound communications at a communication device includes receiving an indicator that an outbound communication is queued for transmission from a wireless-handheld device. At least a first portion of a content portion of the outbound communication is defined by a user associated with the wireless-handheld device. The method also includes analyzing, in response to the receiving, at the wireless-handheld device at least a second portion of the outbound communication based on a rule stored at the wireless-handheld device.

In one or more embodiments, an apparatus and method for monitoring outbound communications at a communication device employ a monitoring module and a rule module. The monitoring module is associated with a communication device. The monitoring module is configured to receive at least one indicator that an outbound text-based communication is queued for transmission from the communication device. In addition, the monitoring module is configured to receive at least one indicator produced in response to a request to establish an audio communication link between the communication device and a server.

In one or more embodiments, the rule module is in communication with the monitoring module. The rule module is configured to analyze a portion of the outbound text-based communication in response to the at least one indicator for the outbound text-based communication. Additionally, the rule module is configured to analyze a portion of a signal associated with the audio communication link in response to the at least one indicator associated with the request.

In one or more embodiments, the at least one indicator for the outbound text-based communication or the at least one indicator associated with the request is received from an operating system of the communication device. In addition, an action module is in communication with the rule module and is configured to send a notification to a user-interface associated with the communication device when a condition is satisfied. Also, the portion of the outbound text-based communication is associated with at least one of a communication protocol portion of the outbound text-based communication or a content portion of the outbound text-based communication.

In one or more embodiments, a portion of the signal includes a destination identifier. In addition, an action module is in communication with the rule module and is configured to send a notification to a user-interface associated with the communication device when the destination identifier of the signal matches a destination identifier associated with a rule. In one or more embodiments, the action module is in communication with the rule module and is configured to prevent transmission of the outbound text-based communication when a condition associated with the rule is satisfied.

In one or more embodiments, a monitoring module of a communication device receives an indicator in response to a request to establish an audio communication link between a communication device and a server. The monitoring module analyzes a portion of at least one of the requests or an outbound signal associated with the audio communication link. The analyzing is in response to the receiving.

In one or more embodiments, a notification request is sent from the outbound-communication-monitoring module of the communication device to a notification module associated with an audio communication module of the communication device. The request is produced by the audio communication module. The receiving includes receiving from the notification module.

In one or more embodiments, a notification is sent to a user-interface of the communication device when the analyzing includes at least one of the portion of the request or the outbound signal satisfying a rule. The portion is associated with an identifier associated with a destination endpoint for the audio communication link. An indicator that the audio communication link has been established is received, and when the outbound signal is transmitted over the audio communication link, the portion is processed.

In one or more embodiments, the audio communication link is based on a first communication protocol. A notification request is sent to a notification module associated with a text-based communication module of the communication device. The text-based communication module is configured to send a text-based communication based on a second communication protocol different than the first communication protocol. In addition, an indicator is received from the notification module that an outbound text-based communication is queued for sending from the communication device. Also, a portion of the text-based communication is analyzed at the monitoring module.

In one or more embodiments, an indicator is received that an outbound communication is queued for transmission from a wireless-handheld device. Also, at least a first portion of a content portion of the outbound communication is defined by a user associated with the wireless-handheld device. In addition, in response to the receiving, at least a second portion of the outbound communication is analyzed at the wireless-handheld device based on a rule stored at the wireless-handheld device. The analyzing includes analyzing before the outbound communication is transmitted from the wireless-handheld device.

In one or more embodiments, the outbound communication has a communication protocol portion. In addition, the second portion is from at least one of the communication protocol portion or the content portion of the outbound communication. Also, the rule is a user-defined rule defined at the wireless-handheld device.

In one or more embodiments, the outbound communication is a text-based message. The rule is received at the wireless-handheld device from a server and associated with a plurality of wireless-handheld devices. A function associated with the wireless-handheld device is performed in response to a condition associated with the rule being satisfied. In response to a condition being satisfied, transmission of the output communication is prevented.

In one or more embodiments, an indicator is received in response to a request to establish an audio communication link between the wireless-handheld device and a server. A portion of at least one of the request or a signal associated with the audio communication link is analyzed based on the rule.

In one or more embodiments, a monitoring module is associated with a wireless-handheld device and is configured to receive an indicator that an outbound communication is queued for transmission from the wireless-handheld device. At least a first portion of the outbound communication is defined by a user associated with the wireless-handheld device. A rule module is configured to analyze a second portion of the outbound communication at the wireless-handheld device different from the first portion before the second portion is transmitted from the wireless-handheld device. The rule module is configured to analyze based on a rule received from an entity separate from the wireless-handheld device.

In one or more embodiments, the outbound communication is at least one of a text-based communication, an audio-based communication, or an image-based communication. In addition, an action module is in communication with the rule module and is configured to send a notification to a user-interface associated with the wireless-handheld device when the rule is satisfied. The monitoring module is configured to prevent transmission of the outbound communication when the rule is satisfied.

In one or more embodiments, an indicator that an outbound communication is queued for transmission from a wireless-handheld device is received. At least a first portion of a content portion of the outbound communication is defined by a user associated with the wireless-handheld device. Also, a request to analyze a second portion of the outbound communication different from the first portion is received based on an outbound rule. In addition, the second portion of the outbound communication is determined to already have been analyzed at the wireless-handheld device based on the outbound rule before the receiving the request. A status of the outbound communication is modified such that transmission of the outbound communication from the wireless-handheld device is prevented until transmission of the outbound communication is approved.

In the following description, numerous details are set forth in order to provide a more thorough description of the system. It will be apparent, however, to one skilled in the art, that the disclosed system may be practiced without these specific details. In the other instances, well known features have not been described in detail so as not to unnecessarily obscure the system.

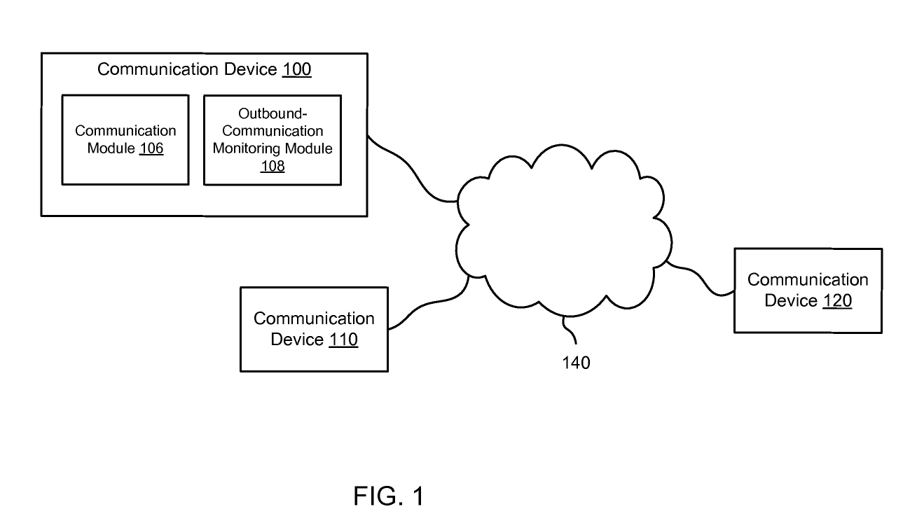

FIG. 1 is a schematic block diagram that illustrates an outbound-communication monitoring module 108 configured to monitor one or more outbound communications before transmission from a communication device 100, according to an embodiment of the present disclosure. An outbound communication can be any type of communication such as a text-based communication (e.g., an e-mail message, an instant message), an audio-based communication (e.g., a voice over Internet protocol (VoIP) call, a Motion Picture Experts Guild (MPEG) audio signal, a push-to-talk audio communication, a cellular communication), and/or an image-based communication (e.g., an electronic slide presentation, an image in a portable document format (pdf), a Joint Photographs Expert Group (JPEG) picture) configured to be sent (e.g., distributed, transmitted) from the communication device 100. In one or more embodiments, the outbound communication can be an outbound signal associated with a communication link such as a request to establish a communication link (e.g., a voice communication link between the communication device 100 and a server (not shown)). If the outbound communication is defined by a user at the communication device 100, the outbound communication can be referred to as a user-defined communication.

In one or more embodiments, monitoring can include, for example, receiving an indicator that an outbound communication is ready for transmission from the communication device 100, analyzing the outbound communication, and/or performing (or triggering performance of) an action based on the analyzing. In this embodiment, the communication device 100 is configured to send (e.g., transmit) the outbound communication to communication device 110 and/or communication device 120 via network 140.

The communication devices 100, 110, and/or 120 can be wired devices (e.g., servers, desktop computers), wireless devices, and/or handheld communication devices (e.g., mobile phones, personal digital assistants (PDAs)). Communication device 110 and/or communication device 120 can be configured to monitor and/or send outbound communications in a fashion similar to communication device 100. Network 140 can include a wireless network, a wired network, a local area network (LAN), a wide area network (WAN), and/or can have one or more segments.

The outbound-communication monitoring module 108 can be configured to analyze any portion of an outbound communication. For example, the outbound-communication monitoring module 108 can be configured to analyze any portion of a text-based message (e.g., a body portion, a subject-line), destination information associated with an outbound communication (e.g., a carbon copy (cc) field, a destination IP address, a destination phone number, a destination handle, a priority flag), any portion of an audio-based message (e.g., a waveform of an audio signal), any portion of an image-based message (e.g., a video signal), and/or any portion of an Internet protocol (IP) packet associated with an outbound communication (e.g., a payload, a header, a priority indicator). The outbound-communication monitoring module 108 can also be configured to analyze any portion of a signal associated with an outbound communication such as, for example, a portion of a request to establish a communication link (e.g., a session initiation protocol message). The outbound-communication monitoring module 108 can also be configured to analyze a notification from an operating system (not shown) of the communication device 100 indicating that an outbound communication message is ready to be sent from the communication device 100.

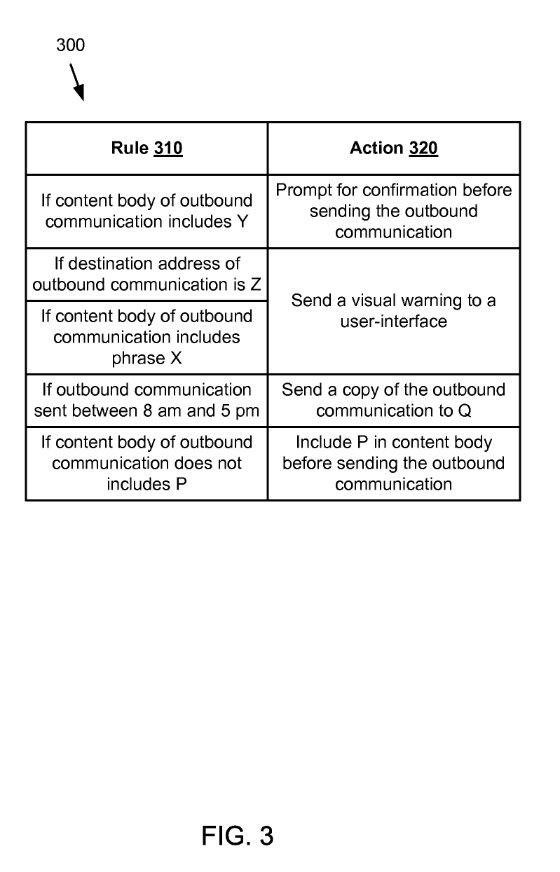

The outbound-communication monitoring module 108 can be configured to analyze outbound communications based on one or more rules that can be associated with one or more actions. In one or more embodiments, the rules can also be referred to as conditions or as outbound rules. Analyzing an outbound communication based on one or more rules can be referred to, for example, as filtering. In one or more embodiments, filtering can also include performing an action or triggering an action. The rules and/or actions can be locally configured and/or stored at the communications device 100, for example, in a memory (not shown). In one or more embodiments, some or all of the rules and/or actions can be remotely configured and/or stored at, for example, a server (not shown). More details related to rules and actions are discussed in connection with FIG. 3.

The outbound communication can be defined at the communication device 100 using, for example, a communication module 106. In one or more embodiments, the communication module 106 can be a text-based communication application, an audio-based communication application, and/or an image-based communication application. In one or more embodiments, the communication module 106 can be associated with (e.g., a component module of) one or more applications such as an e-mail composition application, a multimedia message system (MMS), and/or an audio communication application. The outbound communication can be defined by, for example, a user of at least a portion of the communication device 100.

The outbound-communication monitoring module 108 can be a software module (e.g., a set of instructions executable at a processor, software code) and/or a hardware module (e.g., a processor, an application-specific integrated circuit (ASIC), a field programmable gate array (FPGA), a read-only memory (ROM)). For example, the outbound-communication monitoring module 108 can be a software module installed at the communication device 100 and executed at the communication device 100 using a processor (not shown) and/or a memory (not shown).

In one or more embodiments, an outbound communication defined at communication device 100 can be routed to communication device 110 and/or communication device 120 via one or more communication servers (not shown) after being filtered at and/or sent from communication device 100. If the outbound communication is, for example, an e-mail message, the communication server(s) can be an e-mail server(s) (e.g., mail transfer agent (MTA)). The communication server(s) can be configured to further filter outbound communications sent from, for example, communication device 100 based on a set of rules that can be associated with one or more actions. In such embodiments, the communication server can be, for example, controlled by an entity (not shown) that controls the communication device 110.

In one or more embodiments, the communication devices 100, 110, and/or 120 can be configured to monitor inbound communications in addition to outbound communications. For example, communication device 100 can have an inbound-communication monitoring module (not shown) configured to receive and/or monitor inbound communications. In one or more embodiments, the inbound-communication monitoring module can be associated with functions, rules, and/or actions that are shared or separate from that of the outbound-communication monitoring module 108.

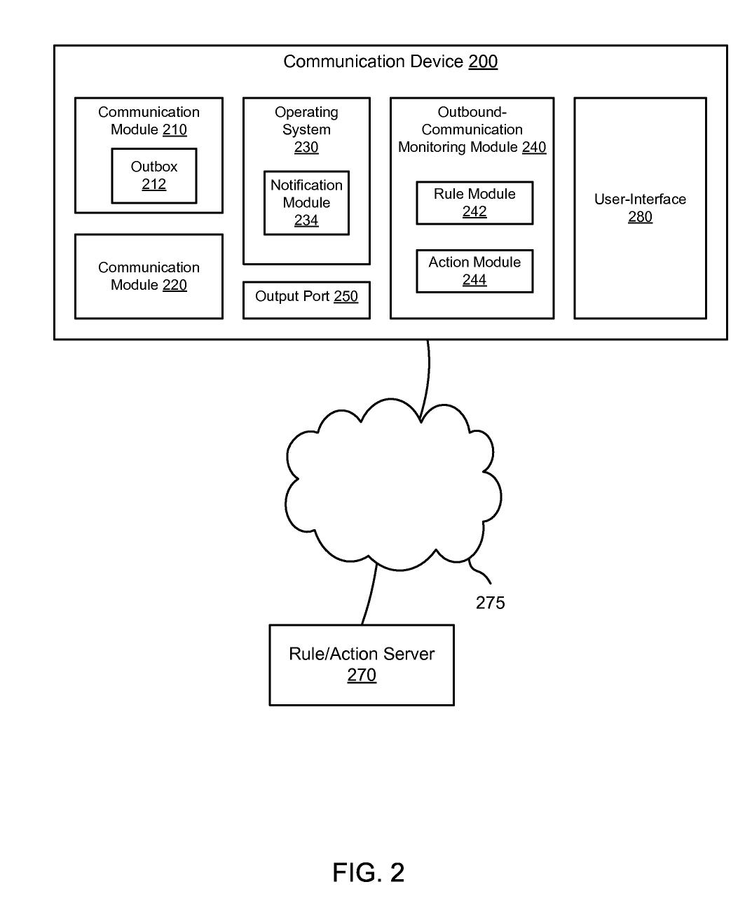

FIG. 2 is a schematic block diagram that illustrates a communication device 200 that has an outbound-communication monitoring module 240, an operating system 230, communication modules 210 and 220, and a user-interface 280, according to an embodiment of the present disclosure. The outbound-communication monitoring module 240 can be configured to monitor one or more outbound communications defined by communication module 210 and/or communication module 220 before the outbound communication(s) are sent (e.g., transmitted) from the communication device 200. The outbound-communication monitoring module 240 can receive an indicator from notification module 234 of the operating system 230 such that outbound-communication monitoring module 240 can intercept (e.g., cause operating system 230 to delay or prevent transmission of the outbound communications) and analyze outbound communications defined at communication module 210 and/or communication module 220 before they are sent from the communication device 200.

The communication modules 210 and 220 can be configured for use by a user of the communication device 200 to define one or more of a text-based outbound communication, an audio-based outbound communication, and/or an image-based outbound communication. In one or more embodiments, communication module 210 can be configured with different capabilities than communication module 220. For example, communication module 210 can be associated with an instant-messaging application configured to be used to define both text-based communications and audio-based communications while communication module 220 can be configured to be used exclusively to define audio-based communications. The communication modules 210 and 220 can be configured to function separately, but in one or more embodiments, the communication modules 210 and 220 can be configured to function in cooperation with each other or another communication module (not shown).

As shown in FIG. 2, communication module 210 has an outbox 212. Outbound communications defined at communication module 210 can be queued in the outbox 212 before being sent from the communication device 200. For example, at least a portion of an outbound communication can be moved to the outbox 212 after a user of the communication device 200 indicates that the outbound communication defined using communication module 210 is ready to be sent from the communication device 200. The portion of the outbound communication can remain (e.g., temporarily remain) in the outbox 212 until sent from the communication device 200 via an output port 250. In one or more embodiments, communication module 220 can also be configured with an outbox (not shown). In one or more embodiments, the outbound communication is not physically moved to the outbox 212, but is associated with the outbox 212 by defining an indicator (e.g., flag, pointer) associated with at least a portion of the outbound communication.

The notification module 234 of the operating system 230 is configured to send an indicator (can also be referred to as an outbound indicator or an event indicator) that an outbound message is ready for sending from communication device 200. The notification module 234 can be configured to send an outbound indicator at any time before an outbound communication is sent from the communication device 200 via output port 250. For example, the notification module 234 of the operating system 230 can send an outbound indicator that an outbound communication has been moved or will be moved to the outbox 212 of the communication module 210. Because communication module 220 does not have an outbox, the notification module 234 can be configured to send an outbound indicator when at least a portion of an outbound communication is prepared by the communication module 220 for transmission from the communication device 200 via the output port 250. The outbound indicator can be configured to include specific information related to the communication type (e.g., information that the outbound communication is a text-based communication) and/or the communication modules 210 and/or 220 (e.g., information that the communication module is configured to define only audio-based communications).

The notification module 234 of the operating system 230 can be configured to send an outbound indicator to one or more modules, such as outbound-communication monitoring module 240, that have registered with (e.g., subscribed to) the notification module 234. Modules that have been registered to receive an outbound indicator(s) from the notification module 234 can be referred to as registered modules. A request to register with the notification module 234 can be referred to as a notification request. The notification request can be defined based on an application programming interface (API) associated with the notification module 234 and/or the operating system 230.

The outbound-communication monitoring module 240 can be configured to analyze at least a portion of an outbound communication in response to an outbound indicator from the notification module 234. The outbound-communication monitoring module 240 can be configured to receive (e.g., intercept) and analyze one or more outbound communications any time before the outbound communications are sent from the communication device 200 via output port 250. In one or more embodiments, the outbound-communication monitoring module 240 can be configured to analyze a set of outbound communications or portions associated with an outbound communication using any combination of series processing (e.g., first-in-first-out basis) and parallel processing.

In one or more embodiments, the outbound-communication monitoring module 240 can register with the notification module 234 (e.g., via a notification request) such that the outbound-communication monitoring module 234 can receive outbound indicator(s) when an outbound communication is at a location where the outbound communication can be accessed and/or analyzed by one or more modules. For example, outbound-communication monitoring module 240 can register with the notification module 234 such that the outbound-communication monitoring module 240 receives an outbound indicator when an outbound communication is moved to the outbox 212 or when transferred to a memory (not shown) such as a buffer associated with the output port 250 where the outbound communication can be accessed and/or analyzed by the outbound-communication monitoring module 240.

In one or more embodiments, the outbound-communication monitoring module 240 can register with the notification module 234 (e.g., via a notification request) such that the outbound-communication monitoring module 234 can receive outbound indicator(s) based on a specific timing of events associated with an outbound communication. For example, the outbound-communication monitoring module 240 can register with the notification module 234 such that the notification module 234 sends an outbound indicator to the outbound-communication monitoring module 240 after an outbound communication is finalized (e.g., saved in a memory) or defined at the communication module 210.

In one or more embodiments, the outbound-communication monitoring module 240 can register with the notification module 234 such that the outbound-communication monitoring module 240 receives outbound indicators associated with a specific communication module or set of communication modules. For example, the outbound-communication monitoring module 240 can be configured to register with notification module 234 to only receive outbound indicators associated with outbound communications defined using communication module 210.

In one or more embodiments, each of the communication modules 210 and 220 can be associated with different notification modules (not shown) that can each handle one or more subscriptions. In one or more embodiments, the functions of the notification module 234 can be incorporated into communication module 210, communication module 220, and/or outbound-communication monitoring module 240. In other words, the sending of outbound indicators can be a service provided by a module (not shown) separate from the operating system 234 of the communication device 200. In one or more embodiments, the outbound-communication monitoring module 240 can have a module (not shown) configured to monitor (e.g., listen to) the output port 250 to detect and intercept an outbound communication before it is transmitted from the communication device 200.

As shown in FIG. 2, the outbound-communication monitoring module 240 has a rule module 242 and an action module 244. The rule module 242 can be configured to analyze any portion (e.g., a predetermined portion or an administrator-specified portion) of an outbound communication based on a rule, and the action module 244 can be configured to perform or to trigger an action associated with the rule. For example, the action module 244 can be configured to trigger an action in response to an indicator from the rule module 242 that a rule has been satisfied based on an analysis of a portion of an outbound communication.

FIG. 3 is a table 300 that illustrates rules 310 and actions 320, according to an embodiment of the present disclosure. In one or more embodiments, a rule 310 can be referred to as a condition. In this table 300, the actions 320 are triggered when the rules 310 are satisfied. For example, if the destination address of an outbound communication is Z, then a visual warning is sent to a user-interface. The visual warning can be, for example, a pop-up message that indicates that the outbound communication is being sent to Z. For example, the destination address Z could be associated with a competitor of the entity that controls the communication device. Also, as shown in table 300, a visual warning is sent to the user-interface if the content body of an outbound communication includes phrase X. For example, the phrase X could relate to a financial transaction typically prohibited on a given communication device.

Table 300 includes only a few examples of rules 310 and actions 320. In one or more embodiments, the rules 310 can be related to, for example, a day of a week (e.g., Monday), a geographic location (e.g., a geographic location of a recipient), an image, an audio signature (e.g., an audio signature related to a voice of a particular person), etc. In one or more embodiments, the actions 320 can be related to the termination or execution of processes (e.g., algorithms, procedures) at a communication device, the sending of e-mail notifications, etc. Although in this embodiment, the rules and actions are shown as separate components, in one or more embodiments, the rules and actions can be combined in a database as a single command and/or processed by a module as such.

Referring back to FIG. 2, although the rule module 242 and action module 244 are shown as separate modules in this embodiment, in one or more embodiments, the functions associated with rule 242 and/or action module 244 can be combined into a single module or separated into several modules. For example, one or more rule modules (not shown) can be associated with communication module 210 and a different (e.g., separate) set of rule modules (not shown) can be associated with communication module 220. In one or more embodiments, for example, one or more action modules (not shown) can be associated with communication module 210 and a different (e.g., separate) set of action modules (not shown) can be associated with communication module 220.

In one or more embodiments, rules and/or actions can be defined, stored, and/or modified (e.g., updated) locally at, for example, communication device 200. Rules and/or actions associated with only communication device 200 can be referred to as local rules and/or actions. For example, a set of rules and/or actions can be a customized set of rules and/or actions associated with communication device 200. In one or more embodiments, the rules and/or actions can be associated with, for example, a profile of a user. The profile can be a roaming profile associated with more than one communication device (not shown) or a profile associated with only communication device 200.

In one or more embodiments, rules and/or actions can be associated with a group or network of communication devices (not shown) that can, for example, include communication device 200. Rules and/or actions associated with a group of communication devices can be referred to as global rules and/or actions. Global rules and/or actions can be defined at, modified at (e.g., updated at), and/or distributed from, for example, rule/action server 270. As shown in FIG. 2, the communication device 200 is in communication with rule/action server 270 via network 275. The global rules and/or actions can be defined by, for example, a network administrator.

In one or more embodiments, global rules and/or actions can be sent (e.g., downloaded) from the rule/action server 270 to the communication device 200 in response to a request from the communication device 200. For example, a user can request a specific global rule/action from the rule/action server 270 via the user-interface 280 of the communication device 200. The rule/action server 270 can be configured to send the specific rule/action in response to the request. In one or more embodiments, the rule/action server 270 can be configured to only send the specific rule/action if authorized to do so by an administrator and/or the communication device 200 is authorized to receive the specific rule/action by an administrator. In one or more embodiments, all or a specified portion of global rules and/or actions from rule/action server 270 can be sent to communication device 200 as part of, for example, a regular update package related to a group of communication devices and provided by an administrator associated with the group of communication devices.

In one or more embodiments, the rule/action server 270 can be configured to back-up or archive, for example, a copy of local rules and/or actions associated with communication device 200. All or a selected set of local rules and/or actions associated with communication device 200 can be uploaded to the rule/action server 270 from the communication device 200 according to a schedule (e.g., at a specified time) or in response to a request from, for example, a user of the communication device 200. In one or more embodiments, the local rules and/or actions associated with communication device 200 can be synchronized periodically, or on a per-request basis, with a copy of the local rules and/or actions at the rule/action server 270.

In one or more embodiments, the rule module 242 can be used to modify one or more global or local rules via the user-interface 280. Likewise, the action module 244 can be used to modify one or more global or local actions via the user-interface 280.

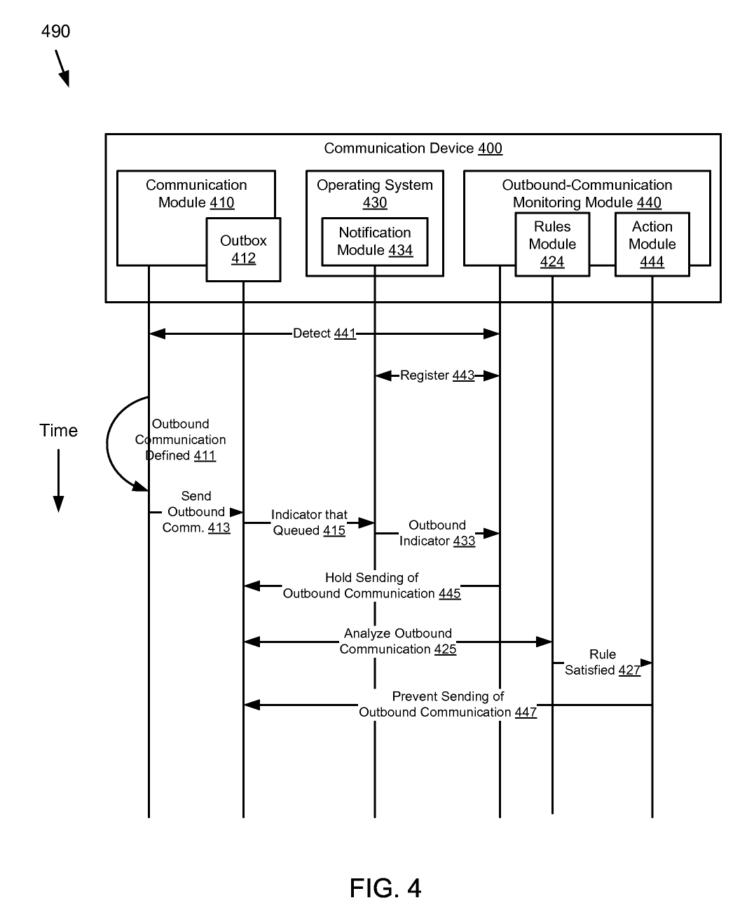

FIG. 4 is a timing diagram 490 that illustrates a sequence of functions performed at a communication device 400 and/or signals transmitted between components of the communication device 400, according to an embodiment of the present disclosure. The communication device 400 has a communication module 410, an operating system 430, and an outbound-communication monitoring module 440. In this timing diagram 490, time is increasing in a downward direction.

As shown in FIG. 4, at 441, the outbound-communication monitoring module 440 of the communication device 400 detects the communication module 410. The communication module 410 can be associated with or can be, for example, an audio-based, an image-based, and/or a text-based communication application. At 441, the communication module 410 can be detected during an initiation sequence associated with the communication device 400, for example, when the communication device 400 is powered-on or booted-up. In one or more embodiments, the communication module 410 can be detected in response to the communication module 410 being launched or in response to the communication module 410 being otherwise made available for use at the communication device 400. In one or more embodiments, the communication module 410 can be made available (e.g., accessible) to other modules of the communication device 400 such as the outbound-communication monitoring module 440 by the operating system 430. In one or more embodiments, the communication module 410 can be detected in response to a signal broadcast by the communication module 410.

In one or more embodiments, the outbound-communication module 410 can periodically query the communication device 400 (e.g., operating system 430) to detect whether or not the communication module 410 is active (e.g., available). For example, the outbound-communication module 410 can query the operating system 430 to attempt to detect the communication module 410 according to a schedule. In one or more embodiments, the communication module 410 can be detected in response to a user's interaction with the communication device 400. For example, a user of the communication device 400 can trigger the outbound-communication monitoring module 440 to detect and then monitor outbound communications defined using communication module 410. In one or more embodiments, a list of communication modules (not shown) available to the communication device 400 can be maintained (e.g., updated) by, for example, the outbound-communication monitoring module 440.

After detecting the communication module 410, at 443, the outbound-communication monitoring module 440 registers (e.g., subscribe) with a notification module 434 associated with the communication module 410. The outbound-communication monitoring module 440 registers with the notification module 434 such that the outbound-communication monitoring module 440 can receive outbound indicators related to outbound communications from the communication module 410. In this embodiment, the notification module 434 is a module configured to send outbound indicators to the outbound-communication monitoring module 440 when an outbound communication, ready for sending from the communication device 400, is queued in an outbox 412 of the communication module 410. The outbound-communication monitoring module 440 can register with the notification module 434 by sending one or more registration requests and receiving one or more responses that can be based on an API for the operating system 430 and/or the communication module 410.

In one or more embodiments, the outbound-communication monitoring module 440 can selectively register to receive outbound indicators associated with a communication module such as communication module 410. For example, the outbound-communication monitoring module 440 can receive a list of communication modules (not shown) available at the communication device 400 from the operating system 430. The outbound-communication monitoring module 440 can determine whether or not to register 443 with the notification module 434 to receive outbound indicators associated with one or more of the communication modules from the list based on monitoring preferences. The monitoring preferences can be, for example, stored in and accessed from a memory (not shown) associated with the communication device 400. In one or more embodiments, the monitoring preferences can be defined by a user (e.g., network administrator). In one or more embodiments, the monitoring preferences can be associated with a profile of a user that can be loaded when the user logs into the communication device 400.

The monitoring preferences can be related to, for example, module type, communication protocol type, communication type, or some other criteria. For example, in one or more embodiments, the outbound-communication monitoring module 440 can be configured to register with notification module 434 to receive outbound indicators related to communication module 410 only if communication module 410 is a text-based communication module or an audio-based communication module. In one or more embodiments, for example, the outbound-communication monitoring module 440 can be configured to register with the notification module 434 to receive outbound indicators associated with the communication module 410 only if the communication module 410 is compatible with one or more particular communication protocols.

At 411, an outbound communication is defined at the communication device 400 using the communication module 410. In one or more embodiments, the outbound communication can be, for example, a text-based message having a content portion defined by a user of the communication device 400 using the communication module 410. In one or more embodiments, the outbound communication can be, for example, a signal configured to establish/request a communication link with another communication device (not shown).

As shown in the timing diagram 490, at 413, the outbound communication is sent to the outbox 412 and at 415, an indicator that the outbound communication is queued for sending from the outbox 412 is sent to the notification module 434. In one or more embodiments, the outbound communication can be queued for sending in response to a request to send or to establish a communication link to send at least a portion of the outbound communication. For example, the outbound communication can be queued for sending in the outbox 412 in response to a user pushing, selecting, or actuating a send button (not shown) associated with the communication device 400.

At 433, the notification module 434 sends to the outbound-communication monitoring module 440 an outbound indicator indicating that the outbound communication is in the outbox 412. In one or more embodiments, the outbound indicator can be sent to the outbound-communication monitoring module 440 in response to the outbound communication being defined at the communication device 400 using the communication module 410.

At 445, the outbound-communication monitoring module 440 sends a signal to the outbox 412 to hold the outbound communication until further notice. While in this holding state, at 425, the outbound communication is analyzed by the rule module 424 at the communication device 400 based on one or more rules. In one or more embodiments, only portions of the outbound communication are analyzed by the outbound-communication monitoring module 440. In one or more embodiments, portions of the outbound communication are requested and sent to the outbound-communication monitoring module 440 for analysis. In one or more embodiments, a signal (not shown) is sent to the operating system 430 to hold the outbound communication so that the outbound communication can be analyzed by the outbound-communication monitoring module 440.

As shown in FIG. 4, at 427, a signal is sent from the rule module 424 indicating that a rule has been satisfied. At 447, the action engine 444 is triggered based on the signal at 427, to send a signal to prevent (e.g., block) sending of the outbound communication. In one or more embodiments, a signal (not shown) is sent from the action engine 444 to the operating system 430 to prevent the outbound communication from being sent by the communication device 400.

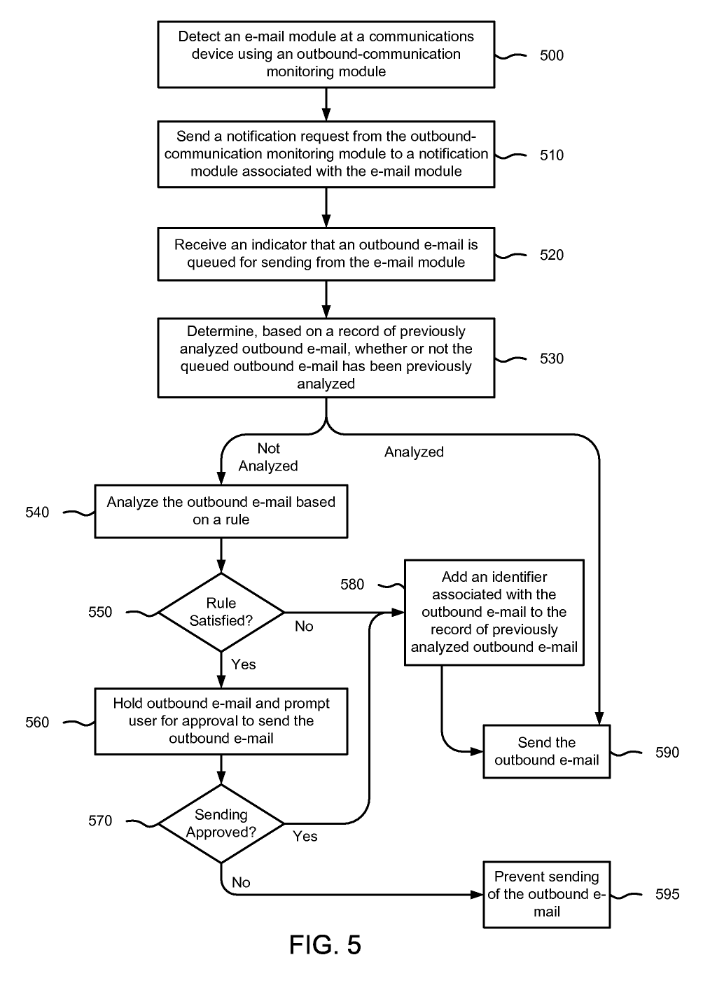

Although this scenario is not shown in FIG. 4, if the outbound communication is not approved for sending because a rule (e.g., condition) is not satisfied, the outbound communication can be re-queued in the outbox 412 such that the outbound communication can be sent (e.g., transmitted) from the communication device 400. In one or more embodiments, the outbound communication can remain in the outbox 412, for example, for hundreds of milliseconds before the outbound communication is finally sent from the communication device 400. To avoid re-analyzing the outbound communication after it has been re-queued in the outbox 412, an indicator that the outbound communication has already been analyzed can be associated with the outbound communication. In one or more embodiments (such as that described in connection with FIG. 5), a record of previously analyzed outbound communications can be defined and checked so that the outbound-communication monitoring module 440 can avoid recursively analyzing queued outbound communications.

In one or more embodiments, the outbound-communication monitoring module 440 can be configured such that a user can, at least temporarily, disable monitoring of outbound communications from the communication module 410. For example, the outbound-communication monitoring 440 can be configured to suspend monitoring of outbound communications from communication module 410 for a specified period of time in response to a request from a user via a user-interface (not shown). This capability can be provided as feature of the outbound-communication monitoring module 440. In one or more embodiments, the outbound-communication monitoring module 440 can be configured such that a user can be prevented from disabling monitoring of outbound communications from the communication module 410. For example, the outbound-communication monitoring module 440 can have one or more security features (e.g., an encrypted portion, a portion accessible only by an administrator) to substantially prevent a user from disabling a monitoring function associated with the outbound-communication monitoring module 440.

FIG. 5 is a flowchart that illustrates a method for monitoring outbound e-mail from an e-mail module at a communication device, according to an embodiment of the present disclosure. The outbound e-mail can be referred to as an outbound e-mail communication. In one or more embodiments, the communication device can be a wireless-handheld communication device.

As shown in FIG. 5, an e-mail module is detected at a communication device using an outbound-communication monitoring module at 500. In one or more embodiments, the outbound-communication monitoring module can be configured to detect only a specific e-mail module (e.g., e-mail service) or type of e-mail module. In one or more embodiments, the outbound-communication monitoring module can be configured to detect only available e-mail modules (e.g., launched e-mail modules, e-mail modules registered with an operating system).

A notification request is sent from the outbound-communication monitoring module to a notification module associated with the e-mail module at 510. The notification request can be defined such that the outbound-communication monitoring module can be registered with the notification module. The notification request can be defined to trigger the notification module to send an indicator to the outbound-communication monitoring module when an outbound e-mail is queued for sending from the e-mail module.

An indicator that an outbound e-mail is queued for sending from the e-mail module is received at the outbound-communication monitoring module at 520. The indicator can be an indicator sent from the notification module when the outbound e-mail is associated with an outbox (e.g., outbox folder) of the e-mail module. In one or more embodiments, the indicator can be defined based on the notification request. For example, the indicator can include information associated with the e-mail module in accordance with the notification request.

A record of previously-analyzed outbound e-mail is probed to determine at 530 whether or not the queued outbound e-mail has been previously analyzed by, for example, a rule module of the outbound-communication monitoring module. The record is probed to ensure that the outbound e-mail is not, for example, an outbound e-mail that has been re-queued after already being analyzed. The list of previously-analyzed outbound e-mail can be defined and/or maintained by the outbound-communication monitoring module based on, for example, unique identifiers associated with each outbound e-mail. An identifier associated with the queued outbound e-mail can be compared against the identifiers included in the record to determine whether or not the queued outbound e-mail has been previously-analyzed. In one or more embodiments, the unique identifiers associated with the outbound e-mails can be defined by, for example, the e-mail module when the outbound e-mail is queued for sending. In one or more embodiments, the record can be included in a database stored in a memory or a text-based list. In one or more embodiments, the record can be a rolling record that includes only recent identifiers (e.g., identifiers defined within the last seven days).

If the outbound e-mail has been previously analyzed as determined at 530, the outbound e-mail can be sent from the communication device at 590. If the outbound e-mail has not been analyzed based on the determination at 530, the outbound e-mail is analyzed based on a rule at 540 by, for example, a rule module. Any portion of the outbound e-mail can be analyzed (e.g., a destination portion, a body portion, an attachment).

If the rule is not satisfied at 550, an identifier associated with the outbound e-mail is added to the record of previously-analyzed outbound e-mail at 580 and the outbound e-mail is sent from the communication device 590. In one or more embodiments, a rule module can be configured to determine whether or not the rule has been satisfied.

If the rule is satisfied at 550, the outbound e-mail is held and a user is prompted to approve sending of the outbound e-mail at 560. In one or more embodiments, the outbound e-mail can be held by changing a status associated with the outbound e-mail. For example, a status (e.g., state) associated with the outbound e-mail can be changed from a pending/queued status to a cancelled status such that the outbound e-mail is held at the e-mail module (or outbox of the e-mail module) without being sent from the communication device. In one or more embodiments, the status of an outbound e-mail can be changed in accordance with an API. In one or more embodiments, by changing the status of a first outbound e-mail to a cancelled status, the first outbound e-mail can be held without being purged and without substantially affecting the processing of a second outbound e-mail.

In one or more embodiments, the outbound e-mail can be held during analysis (rather than after analysis as shown in FIG. 5) by changing a status associated with the outbound e-mail to, for example, a hold status. After the outbound e-mail has been analyzed and/or sending is approved, the status associated with the outbound e-mail can be changed back to, for example, a send status (e.g., pending status) such that the outbound communication can be transmitted from the communication device.

If the outbound e-mail is approved for sending at 570 by, for example, a user of the communication device, an identifier associated with the outbound e-mail can be added to the record of previously-analyzed outbound e-mail at 580 and the outbound e-mail can be sent from the communication device 590. If the outbound e-mail is not approved for sending at 570, sending of the outbound e-mail can be prevented at 595. In one or more embodiments, the outbound e-mail can be purged from the communication device to prevent sending of the outbound e-mail. In one or more embodiments, for example, a notification can be sent to a user (e.g., a notification on a display of the communication device) that authorization for sending of the outbound e-mail has been denied.

Although this scenario is not shown in FIG. 5, in one or more embodiments, if the outbound e-mail has been previously analyzed as determined at 530 and previously rejected as inappropriate for sending (not shown), sending of the outbound e-mail can be prevented at 595.

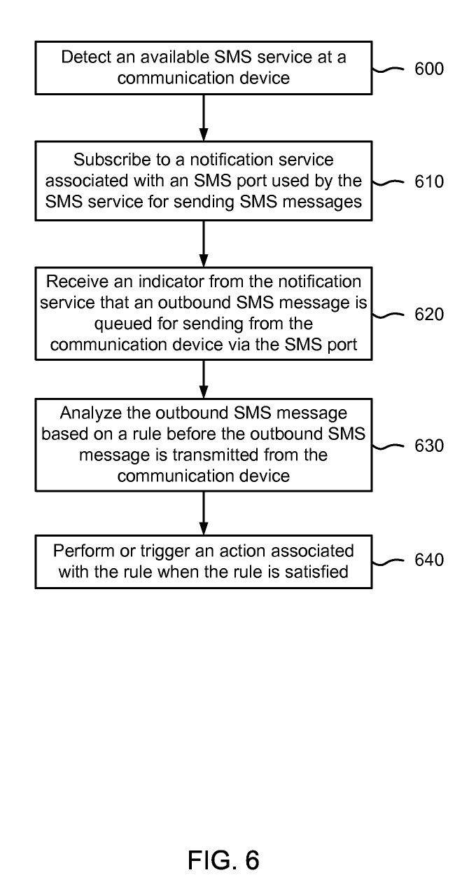

FIG. 6 is a flowchart that illustrates a method for monitoring outbound short-message-service (SMS) messages from an SMS module at a communication device, according to an embodiment of the present disclosure. An available SMS module is detected at a communication device at 600. The SMS module can be, for example, a built-in SMS application on a device or an instant messaging application.

A subscription to a notification service associated with an SMS port used by the SMS module for sending SMS messages is established at 610. The SMS port can be an outgoing port of the communication device. In one or more embodiments, the SMS port can be associated with a specific type of communication protocol used by the SMS module.

An indicator that an outbound SMS message is queued for sending from the communications device via the SMS port is received from the notification service at 620. The outbound SMS message is analyzed based on a rule before the outbound SMS message is transmitted from the communication device at 630. In one or more embodiments, the outbound SMS message can be analyzed by a rules module associated with an outbound-communication monitoring module. An action associated with the rule is performed or triggered when the rule is satisfied at 640.

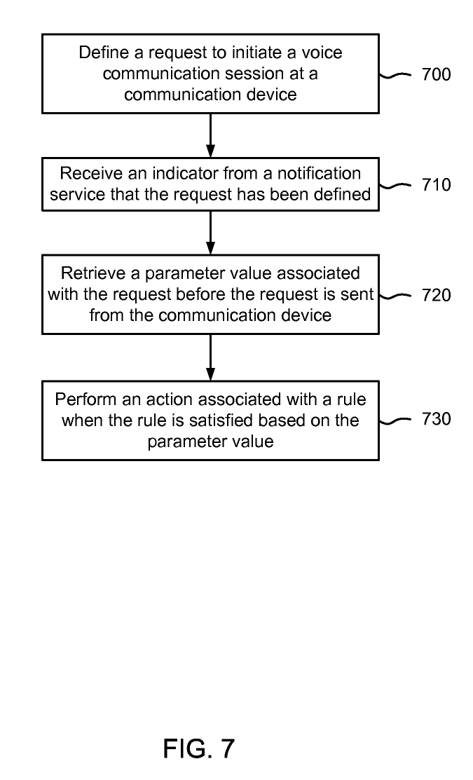

FIG. 7 is a flowchart that illustrates a method for monitoring outbound voice communications at a communication device, according to an embodiment of the present disclosure. A request configured to initiate a voice communication session at a communication device is defined at 700. In one or more embodiments, the voice communication session can be referred to as a voice communication link or call. The communication device can be, for example, a handheld wireless device such as a mobile phone. The request can be defined by, for example, a voice communication module associated with (e.g., installed on) the communication device.

An indicator that the request has been defined is received from a notification service at 710. The indicator can be defined by, for example, the notification service based on a subscription to the notification service. Alternatively, the indicator can be derived from the data and/or messages associated with the notification service. The indicator can include a specific session identifier associated with the voice communication session request.

A parameter value associated with the request is received at 720 before the request is sent from the communication device; an action associated with a rule is performed when the rule is satisfied based on the parameter value at 730. The parameter value can be, for example, a specific destination phone number or an area code of a phone number. The request can be, for example, purged or sending of the request from the communication device can be prevented, if a voice communication session with the destination phone number is restricted based on the rule.

Although FIGS. 5, 6, and 7, respectively, are related to the monitoring of specific types of outbound communications from communication modules, an outbound-communication monitoring module can be configured to monitor simultaneously any combination of these specific types of outbound communications and/or additional types of outbound communications.

One or more embodiments relate to a computer storage product with a computer-readable medium (also can be referred to as a processor-readable medium) having instructions or computer code thereon for performing various computer-implemented operations. The media and computer code (also can be referred to as code) may be those specially designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signals; and hardware devices that are specially configured to store and execute program code, such as ASICs, Programmable Logic Devices (PLDs), and ROM and random-access memory (RAM) devices. Examples of computer code include, but are not limited to, micro-code or micro-instructions, machine instructions, such as produced by a compiler, and files containing higher-level instructions that are executed by a computer using an interpreter. For example, an embodiment of the present disclosure may be implemented using Java, C++, or other object-oriented programming language and development tools. Additional examples of computer code include, but are not limited to, control signals, encrypted code, and compressed code.

In conclusion, among other things, methods and apparatus related to monitoring outbound communications at a communication device are described. While various embodiments have been described above, it should be understood that they have been presented by way of example only, and various changes in form and details may be made. For example, multiple outbound-communication monitoring modules can be configured to operate together to collectively analyze outbound communications from a communication device.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

In addition, although certain illustrative embodiments and methods have been disclosed herein, it can be apparent from the foregoing disclosure to those skilled in the art that variations and modifications of such embodiments and methods can be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

1. An apparatus, comprising:
a monitoring module associated with a communication device,
the monitoring module is configured to receive at least one indicator that an outbound text-based communication is queued for transmission from the communication device,
the monitoring module configured to receive at least one indicator produced in response to a request to establish an audio communication link between the communication device and a server; and
a rule module in communication with the monitoring module,
the rule module is configured to analyze a portion of the outbound text-based communication in response to the at least one indicator for the outbound text-based communication,
the rule module is configured to analyze a portion of a signal associated with the audio communication link in response to the at least one indicator associated with the request.

2. The apparatus of claim 1, wherein the at least one indicator for the outbound text-based communication or the at least one indicator associated with the request is received from an operating system of the communication device.

3. The apparatus of claim 1, further comprising:
an action module in communication with the rule module and configured to send a notification to a user-interface associated with the communication device when a condition is satisfied.

4. The apparatus of claim 1, wherein the portion of the outbound text-based communication is associated with at least one of a communication protocol portion of the outbound text-based communication or a content portion of the outbound text-based communication.

5. The apparatus of claim 1, wherein the portion of the signal includes a destination identifier,
the apparatus further comprising:
an action module in communication with the rule module and configured to send a notification to a user-interface associated with the communication device when the destination identifier of the signal matches a destination identifier associated with a rule.

6. The apparatus of claim 1, further comprising:
an action module in communication with the rule module and configured to prevent transmission of the outbound text-based communication when a condition associated with the rule is satisfied.

7. A method, comprising:
receiving at a monitoring module of a communication device an indicator in response to a request to establish an audio communication link between a communication device and a server; and
analyzing at the monitoring module a portion of at least one of the request or an outbound signal associated with the audio communication link, the analyzing being in response to the receiving.

8. The method of claim 7, further comprising:
sending a notification request from the outbound-communication-monitoring module of the communication device to a notification module associated with an audio communication module of the communication device, the request being produced by the audio communication module, the receiving includes receiving from the notification module.

9. The method of claim 7, further comprising:
sending a notification to a user-interface of the communication device when the analyzing includes at least one of the portion of the request or the outbound signal satisfying a rule.

10. The method of claim 7, wherein the portion is associated with an identifier associated with a destination endpoint for the audio communication link.

11. The method of claim 7, further comprising:
receiving an indicator that the audio communication link has been established; and
processing the portion when the outbound signal is transmitted over the audio communication link.

12. The method of claim 7, the audio communication link is based on a first communication protocol,
the method further comprising:
sending a notification request to a notification module associated with a text-based communication module of the communication device, the text-based communication module configured to send a text-based communication based on a second communication protocol different than the first communication protocol;
receiving an indicator from the notification module that an outbound text-based communication is queued for sending from the communication device; and
analyzing a portion of the text-based communication at the monitoring module.

13. A method, comprising:
receiving an indicator that an outbound communication is queued for transmission from a wireless-handheld device, at least a first portion of a content portion of the outbound communication being defined by a user associated with the wireless-handheld device; and
analyzing, in response to the receiving, at the wireless-handheld device at least a second portion of the outbound communication based on a rule stored at the wireless-handheld device.

14. The method of claim 13, wherein the analyzing includes analyzing before the outbound communication is transmitted from the wireless-handheld device.

15. The method of claim 13, wherein the outbound communication has a communication protocol portion, the second portion is from at least one of the communication protocol portion or the content portion of the outbound communication.

16. The method of claim 13, wherein the rule is a user-defined rule defined at the wireless-handheld device.

17. The method of claim 13, wherein the outbound communication is a text-based message, the rule is received at the wireless-handheld device from a server and associated with a plurality of wireless-handheld devices.

18. The method of claim 13, further comprising:
performing a function associated with the wireless-handheld device in response to a condition associated with the rule being satisfied.

19. The method of claim 13, further comprising:
preventing transmission of the outbound communication in response to a condition being satisfied.

20. The method of claim 13, further comprising:
receiving an indicator in response to a request to establish an audio communication link between the wireless-handheld device and a server; and
analyzing a portion of at least one of the request or a signal associated with the audio communication link based on the rule.
